(19) United States
(12) Patent Application Publication
(10) Pub. No.: US 2023/0091376 A1
(43) Pub. Date: Mar. 23, 2023

(54) DETERIORATION PREDICTION SYSTEM, DETERIORATION PREDICTION METHOD, AND RECORDINGMEDIUM FOR STORING PROGRAM

(71) Applicant: NEC Corporation, Minato-ku, Tokyo (JP)

(72) Inventors: Nana JUMONJI, Tokyo (JP); Yutaka YAMANAKA, Tokyo (JP); Hidenori TSUKAHARA, Tokyo (JP); Kaori IWAFUCHI, Tokyo (JP); Maiko HASEGAWA, Tokyo (JP); Kazuki INAGAKI, Tokyo (JP)

(73) Assignee: NEC Corporation, Minato-ku, Tokyo (JP)

(21) Appl. No.: 17/908,357

(22) PCT Filed: Feb. 24, 2021
(86) PCT No.: PCT/JP2021/006869

§ 371 Date: Aug. 31, 2022

(30) Foreign Application Priority Data
Mar. 27, 2020 (JP) 2020-057434

(51) Int. Cl. G06N 5/022

(52) U.S. Cl. CPC G06N 5/022

(57) ABSTRACT

A deterioration prediction system according to an aspect of the present disclosure includes: at least one memory configured to store instructions; and at least one processor configured to execute the instructions to: predict a deterioration level of the road at prediction time points according to road inspection data and the prediction time points, the road inspection data obtained by inspecting a road and the prediction time points indicating future time points, and superimpose the deterioration level on a map for each of the prediction time points in a display mode according to the deterioration level.

### TECHNICAL FIELD

The present disclosure relates to displaying a deterioration prediction.

### BACKGROUND ART

Systems that support inspection and repair of roads for maintenance of roads have been proposed (see, for example, PTL 1 and PTL 2). An inspection support system described in PTL 1 visualizes a deterioration state of a road based on a result of analyzing the deterioration state of the road, and creates a plan regarding inspection and repair of the road. A road maintenance support system described in PTL 2 classifies a degree of deterioration of a road based on an inspection result of the road, predicts a future deterioration tendency of the road, and presents a repair plan draft regarding a repair area, a repair time, and a repair scale.

### CITATION LIST

### Patent Literature

[PTL 1] JP 2019-057192 A
[PTL 2] JP 2005-115687 A

### SUMMARY OF INVENTION

### Technical Problem

In general, a repair cycle is determined for each road, and an inspection plan and a repair plan are formulated based on the repair cycle. However, the degree of deterioration of roads varies depending on traffic conditions, weather, and the like, and it is required to make an appropriate repair plan according to the deterioration state of each road.

An object of the present disclosure is to provide a deterioration prediction system and the like with which an area and time to repair a road can be efficiently grasped.

### Solution to Problem

A deterioration prediction system according to an aspect of the present disclosure includes: a deterioration prediction unit that predicts, based on road inspection data obtained by inspecting a road and prediction time points indicating future time points, a deterioration level of the road at the prediction time points; and a display control unit that displays the deterioration level predicted at the road in a superimposed manner on a map for each of the prediction time points in a display mode according to the deterioration level.

A deterioration prediction method according to an aspect of the present disclosure includes: predicting, based on road inspection data obtained by inspecting a road and prediction time points indicating future time points, a deterioration level of the road at the prediction time points; and displaying the deterioration level predicted at the road in a superimposed manner on a map for each of the prediction time points in a display mode according to the deterioration level.

A program according to an aspect of the present disclosure causes a computer to execute: predicting, based on road inspection data obtained by inspecting a road and prediction time points indicating future time points, a deterioration level of the road at the prediction time points; and displaying the deterioration level predicted at the road in a superimposed manner on a map for each of the prediction time points in a display mode according to the deterioration level.

### Advantageous Effects of Invention

According to the present disclosure, it is possible to efficiently grasp an area and time to repair a road.

### BRIEF DESCRIPTION OF DRAWINGS

FIG. 1 is a block diagram illustrating an example of a road management system.

FIG. 2 is a diagram illustrating an example of road inspection data.

FIG. 3 is a block diagram illustrating an example of a configuration of a deterioration prediction system according to a first example embodiment.

FIG. 4 is a diagram illustrating an example of a deterioration curve of a road.

FIG. 5 is a flowchart illustrating an operation of the deterioration prediction system of the first example embodiment.

FIG. 6 is a flowchart illustrating an operation of deterioration prediction processing.

FIG. 7 is a diagram illustrating a display example of a current deterioration level of a road.

FIG. 8 is a diagram illustrating a display example of a deterioration level of a road two years later.

FIG. 9 is a diagram illustrating a display example of a deterioration level of a road four years later.

FIG. 10 is a flowchart illustrating an operation of a deterioration prediction system of a second example embodiment.

FIG. 11 is a diagram illustrating an example in which an area to be repaired of a repair plan is added to the display example illustrated in FIG. 9.

FIG. 12 is a diagram illustrating a display example of a deterioration level of a road four years later on which a repair plan 1 is reflected.

FIG. 13 is a diagram illustrating a display example of a deterioration level of a road four years later on which a repair plan 2 is reflected.

FIG. 14 is a diagram illustrating a display example of a deterioration level of a road four years later on which a revision proposal is reflected.

FIG. 15 is a diagram illustrating a hardware configuration by a computer.

### EXAMPLE EMBODIMENTS

Next, example embodiments of the present disclosure will be described with reference to the drawings. The present disclosure is not limited to the description of each drawing. Similar configurations in drawings are denoted by the same reference numerals, and a repeated description of them may be omitted. In the drawings used in the following description, configurations of portions not related to the description of the present disclosure may be omitted and not illustrated.

### First Example Embodiment

Hereinafter, a deterioration prediction system of a first example embodiment and a road management system including the deterioration prediction system will be described with reference to the drawings.

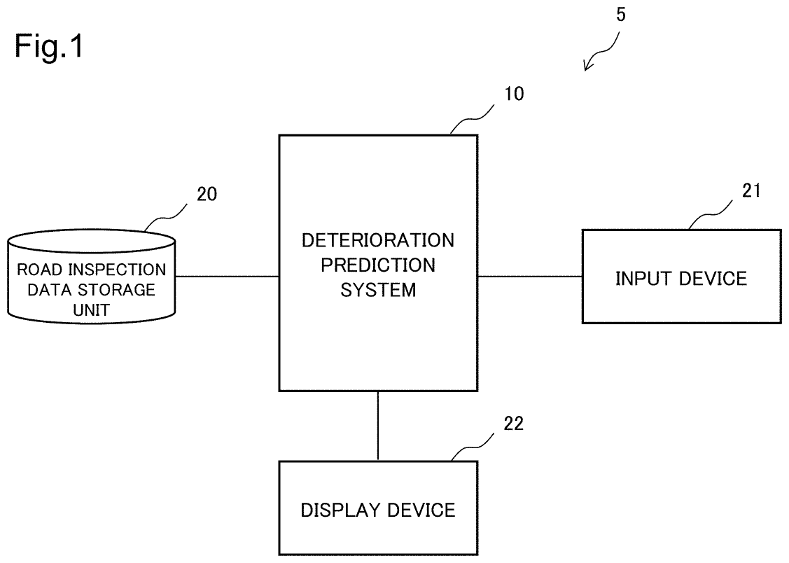

FIG. 1 is a schematic diagram illustrating an outline of a road management system. In a road management system 5 illustrated in FIG. 1, a deterioration prediction system 10 includes a road inspection data storage unit 20, an input device 21, and a display device 22. The deterioration prediction system 10 is communicably connected to the road inspection data storage unit 20, the input device 21, and the display device 22.

The deterioration prediction system 10 predicts, based on road inspection data obtained by inspecting a road and prediction time points indicating future time points, a deterioration level of the road at the prediction time points, and displays the deterioration level predicted at the road in a superimposed manner on a map for each of the prediction time points in a display mode according to the deterioration level. The deterioration prediction system 10 will be described later.

The road inspection data storage unit 20 stores road inspection data and a history of the road inspection data. The road inspection data includes a result of road deterioration diagnosis by a road inspection system (not illustrated) and measurement data used for the deterioration diagnosis. The result of the deterioration diagnosis is, for example, a deterioration degree representing a deterioration state of a road.

The expression form of the deterioration degree is optional. For example, a numerical value may be used as the deterioration degree. Alternatively, characters and symbols may be used as the deterioration degree in addition to numerical values. The deterioration degree may be calculated for a part or the whole of a certain road section. The deterioration degree may be calculated for a part of a measurement location of a certain road section. A known method can be applied as a method used for calculating the deterioration degree used for the deterioration diagnosis of the road.

For example, a crack rate of a road surface may be used as the deterioration degree. In this case, the value of the deterioration degree is in the range of 0.0 to 1.0 (0% to 100%). Alternatively, each example embodiment may use a rutting amount as the deterioration degree. In this case, the value of the deterioration degree is generally an integer of 0 or more (in units of mm). A rational number may be used as the value of the rutting amount. Alternatively, each example embodiment may use an International Roughness Index (IRI) as the deterioration degree. In this case, the value of the deterioration degree is a rational number of 0 or more (in units of mm/m).

In the following description, the crack rate will be used as an example of the deterioration degree. Therefore, in the following description, the value of the deterioration degree increases as the deterioration degree becomes worse. However, as a value of the deterioration degree, a numerical value in which the value decreases as the deterioration degree becomes worse may be used owing to processing using the deterioration degree. It can also be said that the deterioration degree of the road is obtained by quantifying the deterioration state of the road.

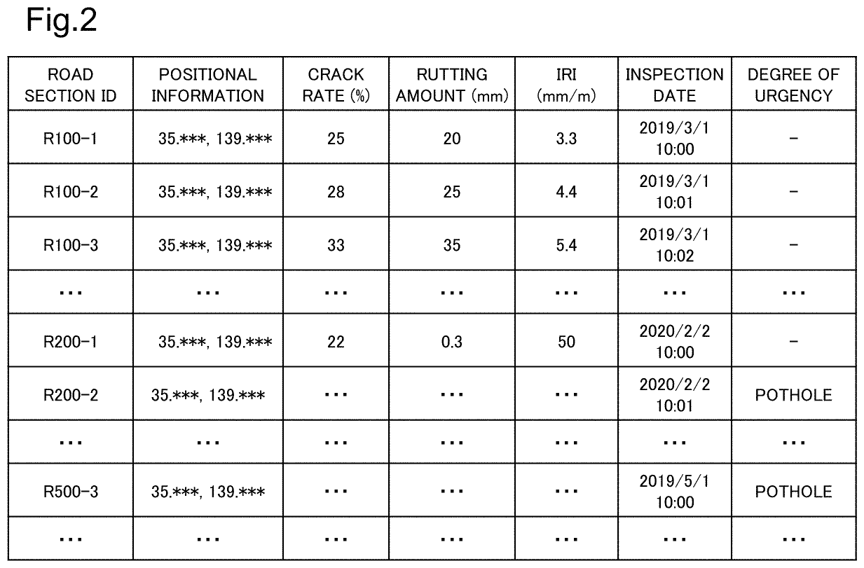

The road inspection data storage unit 20 transmits the road inspection data to the deterioration prediction system 10. FIG. 2 is a diagram illustrating an example of the road inspection data. The road inspection data is used, for example, for generation of a deterioration prediction model, display data indicating a deterioration state of a road, and the like.

The input device 21 receives an input of a time point at which future deterioration (hereinafter, also referred to as a prediction time point) is predicted, from a user or the like. For example, the prediction time point is elapsed years (1 year later, 2 years later, 3 years later, etc.) from the present time. The input device 21 then transmits the received prediction time point to the deterioration prediction system 10. The prediction time point may be a future year (anno Domini).

The input device 21 may receive an input of information different from the prediction time point in addition to the prediction time point, and transmit the information to the deterioration prediction system 10. For example, the input device 21 may receive a road repair plan. Alternatively, the input device 21 may receive an input of auxiliary information for generating a deterioration prediction model in the deterioration prediction system 10. In either case, the input device 21 transmits the received information to the deterioration prediction system 10.

The deterioration prediction system 10 may include the input device 21. For example, the input device 21 may be a keyboard, a mouse, or a touch pad.

The display device 22 receives the display data (such as a result of the deterioration prediction) output from the deterioration prediction system 10, and displays the received display data. The deterioration prediction system 10 may include the display device 22. For example, the display device 22 may be a liquid crystal display or the like.

Alternatively, the display device 22 and the input device 21 may be included in one device instead of being individual devices. For example, the display device 22 and the input device 21 may be achieved by using a computer device including a liquid crystal display, a keyboard, and a mouse. Alternatively, the display device 22 and the input device 21 may be achieved by using a touch panel including a touch pad and a liquid crystal display. Furthermore, the road inspection data storage unit 20, the input device 21, and the display device 22 may be included in one device.

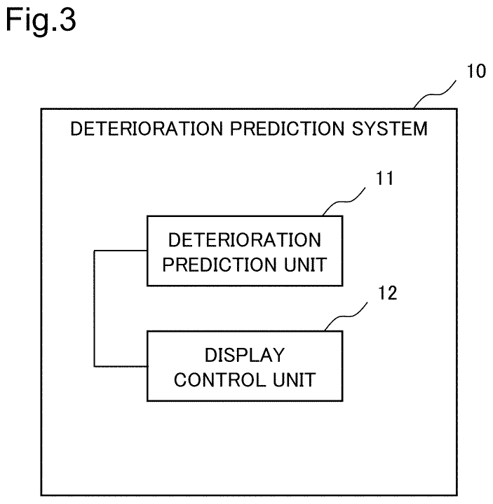

(Deterioration Prediction System) A configuration of the deterioration prediction system 10 according to the first example embodiment will be described with reference to the drawings. FIG. 3 is a block diagram illustrating an example of a configuration of the deterioration prediction system according to the first example embodiment. The deterioration prediction system 10 includes a deterioration prediction unit 11 and a display control unit 12.

The deterioration prediction unit 11 predicts, based on road inspection data obtained by inspecting a road and prediction time points indicating future time points, a deterioration level of the road at the prediction time points. Hereinafter, an example of prediction of the deterioration level of the road at the prediction time points by the deterioration prediction unit 11 will be described.

For example, the deterioration prediction unit 11 acquires a history of road inspection data from the road inspection data storage unit 20, and acquires prediction time points and reference information from the input device 21. The deterioration prediction unit 11 generates a deterioration prediction model for predicting deterioration based on a history of the road inspection data and the reference information. An example of the deterioration prediction model generated by the deterioration prediction unit 11 is a deterioration curve of a road. Hereinafter, an example in which a deterioration prediction model is generated using reference information such as a traffic volume of a road in order to improve the accuracy of the deterioration prediction model will be described, but the present disclosure is not limited to this. For example, it goes without saying that the deterioration prediction unit 11 may generate a deterioration prediction model without using information such as reference information.

The reference information is optional. The reference information is determined in accordance with a target of deterioration prediction, deterioration to be predicted, a deterioration prediction model to be generated, and the like. The reference information includes, for example, information related to a traffic volume of a road and vehicle weights (such as the ratio of large, medium, and ordinary automobiles). Alternatively, past repair information on the road may be included as the reference information. The repair information is, for example, an area to be repaired, a repair time, a repair method, and the like.

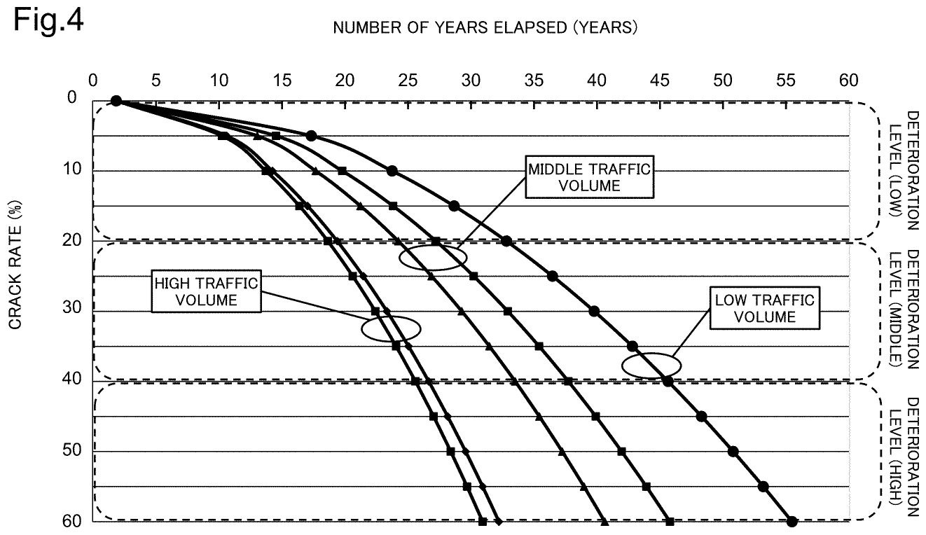

FIG. 4 is a diagram illustrating an example of a deterioration curve of a road. The deterioration curve in FIG. 4 represents a change in a crack rate (deterioration degree) of a road with time. The deterioration curve depends on the traffic volume of the road. Therefore, in the example illustrated in FIG. 4, five deterioration curves depending on the traffic volume are set.

For example, the deterioration prediction unit 11 selects a deterioration curve depending on the traffic volume of the road based on the information on the traffic volume of the road. In the selected deterioration curve, a point equal to the crack rate (deterioration degree) of the road inspection data of the road is the present time (present time point), and the right side of the present time point is a future time point on the time axis. In this way, the deterioration of the road predicted at a future point of time by the deterioration curve illustrated in FIG. 4 indicates a crack rate (deterioration degree) along the deterioration curve with time.

The deterioration curve illustrated in FIG. 4 depicts the correspondence between the crack rate and the deterioration level. In the drawing, the deterioration level is set to a deterioration level (low), a deterioration level (middle), and a deterioration level (high) depending on the crack rate. The deterioration level is not limited to three stages. It can also be said that the deterioration level of the road is obtained by quantifying the degree of deterioration of the road.

The deterioration prediction unit 11 may generate a deterioration prediction model for a part of a road (measurement point) or for each road. A material of a road surface (such as concrete or asphalt), an area where repair is performed, a period, and a method are different for each road. A deterioration prediction model may be generated by assuming these different conditions.

The deterioration prediction unit 11 may determine deterioration that is likely to occur based on a history of the road inspection data. Alternatively, the deterioration prediction unit 11 may divide roads into a plurality of groups based on a user's instruction, a predetermined standard, or the like, and generate a deterioration prediction model for each group.

The deterioration prediction unit 11 may generate a deterioration prediction model that predicts a change in a deterioration type on a road at a prediction time point. The deterioration types include, for example, a lateral crack, a longitudinal crack, a tortoise-like crack, a pothole, and the like.

In the above description, an example has been described in which the deterioration prediction unit 11 generates the deterioration prediction model based on the road inspection data, but the present disclosure is not limited to this. For example, the deterioration prediction model may be acquired from the input device 21 or the like, and the deterioration level of the road at the prediction time point may be predicted using the acquired deterioration prediction model.

The display control unit 12 displays the deterioration level predicted at the road in a superimposed manner on a map for each prediction time point in a display mode according to the deterioration level. For example, the display control unit 12 generates and outputs display data of a display mode according to the deterioration level of the road. The output destination is, for example, the display device 22. The display control unit 12 may use a map stored in a storage unit (not illustrated) of the deterioration prediction system 10 for display, and may use a map acquired from the road inspection data storage unit 20 or the input device 21 for display.

The display data output by the display control unit 12 is not limited to the deterioration information according to the deterioration level of the road at a prediction time point. For example, the display control unit 12 may include a shot image representing the deterioration state of the road at the present time in the display data and output the display data. In a case where the deterioration level of the road changes or the type of deterioration changes due to a change in the prediction time point, the display control unit 12 may display and output it in an expression mode indicating the change.

### [Description of Operation]

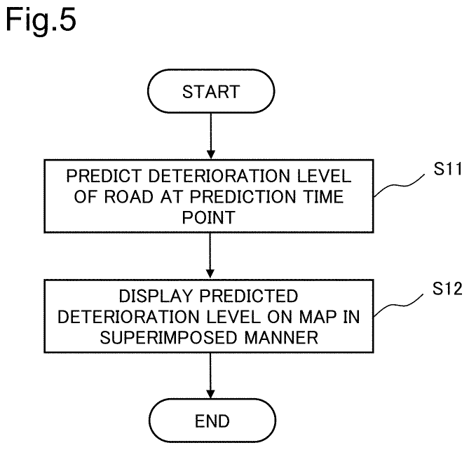

Next, an operation of the deterioration prediction system 10 according to the first example embodiment will be described with reference to the drawings. FIG. 5 is a flowchart illustrating an operation of the deterioration prediction system 10.

The deterioration prediction unit 11 predicts the deterioration level of the road at the prediction time point (step S11). The display control unit 12 displays the predicted deterioration level in a superimposed manner on the map (step S12).

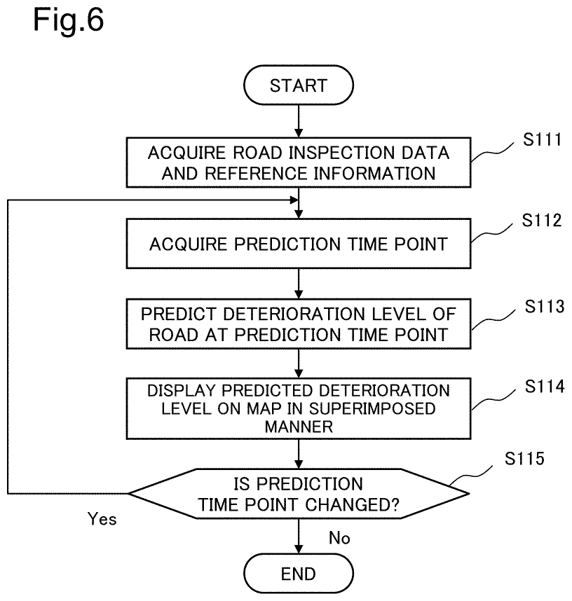

Hereinafter, a detailed example of the operation of the deterioration prediction system 10 will be described with reference to FIG. 6. FIG. 6 is a flowchart illustrating a detailed example of an operation of the deterioration prediction system 10.

The deterioration prediction unit 11 acquires road inspection data and reference information (step S111). For example, the deterioration prediction unit 11 acquires road inspection data of a road and a history of the road inspection data from the road inspection data storage unit 20, and acquires reference information including a traffic volume of the road from the input device 21. The deterioration prediction unit 11 acquires a future prediction time point from the input device 21 (step S112). The deterioration prediction unit 11 generates a deterioration prediction model by using the history of the road inspection data and the reference information. The deterioration prediction unit 11 predicts a deterioration level of the road by applying the prediction time point to the generated deterioration prediction model (step S113).

The display control unit 12 displays the predicted deterioration level in a superimposed manner on the map (step S114). When the future prediction time point is changed (Yes in step S115), the input device 21 receives an input of another prediction time point, and the deterioration prediction unit 11 acquires another future prediction time point (to step S112). When the future prediction time point is not changed (No in step S115), the deterioration prediction system 10 ends the operation. The deterioration prediction system 10 may repeat the operations of steps S111 to S115.

### Display Examples

Next, an operation of the deterioration prediction system 10 will be described with reference to the display examples. In the following description, it is assumed that the display device 22 and the input device 21 may be achieved by using a computer including a liquid crystal display, a keyboard, and a mouse.

Upon receiving the prediction time point, the deterioration prediction system 10 predicts a deterioration level of a road at the prediction time point on an inspected road (a road with road inspection data) on the map, and displays it in a superimposed manner on the map in an expression mode according to the predicted deterioration level.

In the following display example, it is assumed that the display indicating the present deterioration level of the road and the display indicating the future deterioration level of the road can be switched by a deterioration prediction ON/OFF button. Furthermore, when the deterioration prediction is ON, the display indicating the deterioration level of the road at each prediction time point can be switched and displayed by a button for changing a future prediction time point (1 year later, 2 years later, etc.).

For example, the user operates the mouse and clicks the mouse with the mouse pointer overlapped with a predetermined button on the display screen, in such a way that the deterioration prediction system 10 acquires information of ON/OFF of the deterioration prediction or a future prediction time point. The example has been described in which the prediction time point is displayed and selected by a button, but the present disclosure is not limited to this. For example, the prediction time point may be displayed and selected by a scroll bar. In this case, the prediction time point is obtained with reference to the position of a knob in the scroll bar.

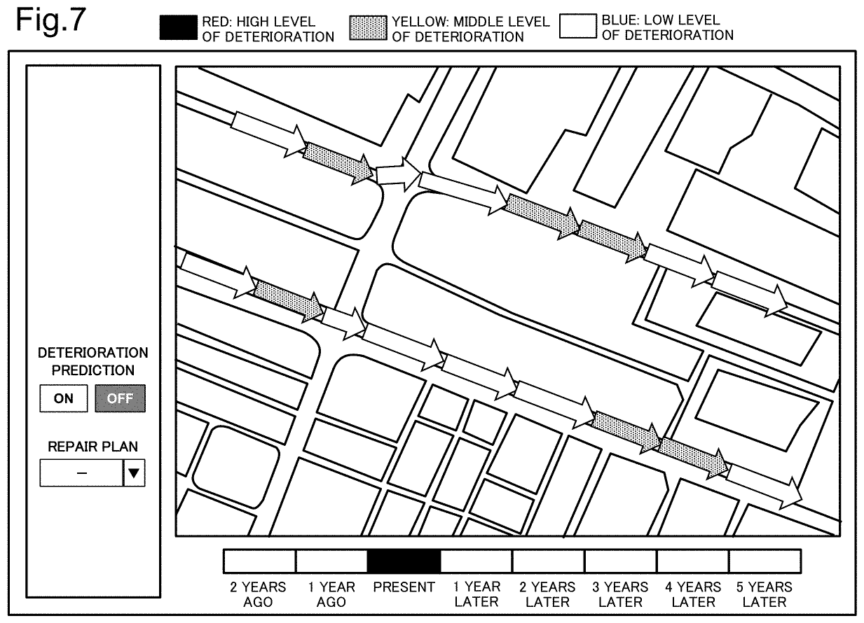

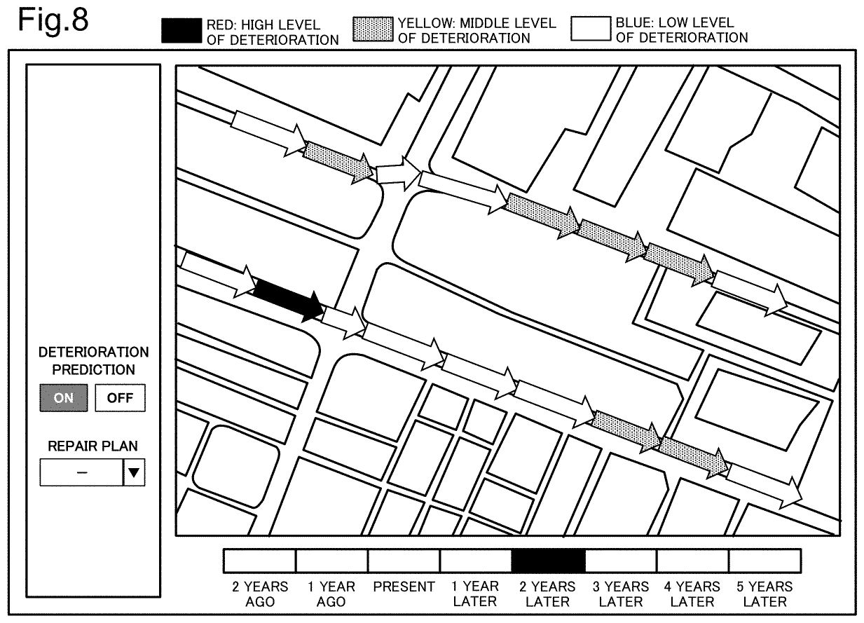

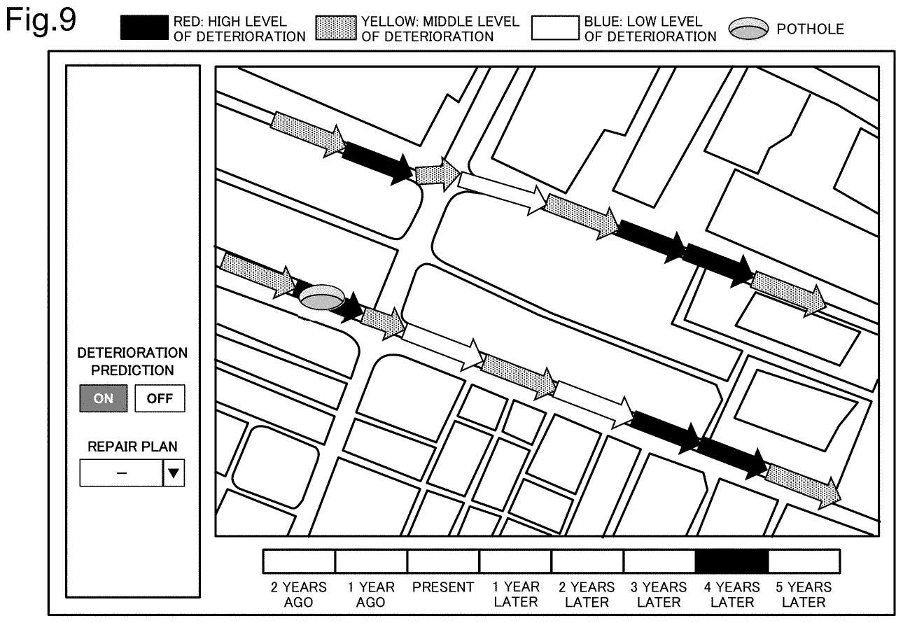

FIG. 7 is a diagram of a display example illustrating a present deterioration level of a road. In the drawing, the deterioration prediction button is displayed as OFF. In FIG. 7, an arrow displayed in a superimposed manner on a road on a map indicates an inspected road (a road having road inspection data). The drawing depicts the deterioration level of the road in three stages: high deterioration (high deterioration level), middle deterioration (middle deterioration level), and low deterioration (low deterioration level). As a deterioration level of the road illustrated in FIG. 7, large deterioration is displayed in red, middle deterioration is displayed in yellow, and low deterioration is displayed in blue. In the drawing, the red color of the arrow is indicated by black, the yellow color is indicated by gray, and the blue color is indicated by white, for convenience in writing. FIGS. 8 and 9 are similarly displayed. As for the deterioration level of the road at present time (present time point) illustrated in FIG. 7, the number of areas with high deterioration is 0, the number of areas with middle deterioration is 6, and the number of areas with low deterioration is 11.

FIG. 8 is a diagram of a display example illustrating a deterioration level of a road two years later. In FIG. 8, an aging button indicating the prediction time point can be clicked by clicking a deterioration prediction ON button. When the user clicks a desired aging button, the deterioration prediction system 10 acquires a prediction time point and predicts a deterioration level of the road at the designated prediction time point. As to the deterioration level of the road two years later illustrated in FIG. 8, the number of areas with high deterioration is 1, the number of areas with middle deterioration is 6, and the number of areas with low deterioration is 10. In the drawing, the deterioration level is changed from middle deterioration to high deterioration in one area and from low deterioration to middle deterioration in one area.

FIG. 9 is a diagram of a display example illustrating a deterioration level of a road four years later. As to the deterioration level of the road four years later illustrated in FIG. 9, the number of areas with high deterioration is 6, the number of areas with middle deterioration is 8, and the number of areas with low deterioration is 3. In the drawing, the deterioration level is changed from middle deterioration to high deterioration in five areas and from low deterioration to middle deterioration in six areas. When the occurrence of a pothole is predicted at the prediction time point by the deterioration prediction unit 11, the display control unit 12 displays the occurrence of a pothole at the prediction time point. In FIG. 9, an icon indicating the presence of a pothole is displayed in a superimposed manner on a road on which a pothole is predicted to occur four year later.

The display control unit 12 may display a deterioration degree (such as crack rate, rutting amount, and IRI) of the designated road. The display control unit 12 may continuously change the display from the present time point to the designated future prediction time point. For example, the display control unit 12 may continuously display and output a deterioration level of a road at a future prediction time point as a moving image.

The user of the deterioration prediction system 10 can refer to the deterioration of the road while changing the prediction time point. Therefore, the user can grasp the predicted time of occurrence of predetermined deterioration by using the deterioration prediction system 10.

### Description of Advantageous Effects

With the deterioration prediction system 10 according to the first example embodiment, an area and time to repair a road can be efficiently grasped. The reason is as follows.

The deterioration prediction system 10 includes the deterioration prediction unit 11 and the display control unit 12. The deterioration prediction unit 11 generates a deterioration prediction model for predicting a deterioration level on a road based on a history of road inspection data and reference information. The deterioration prediction unit 11 predicts the deterioration level of the road at the prediction time point using the generated deterioration prediction model. The display control unit 12 displays the deterioration level of the road at the prediction time point in a superimposed manner on the map.

The user of the deterioration prediction system 10 can grasp an area with high deterioration level, an area with deterioration level changed, and a degree of progress of deterioration depending on the prediction time point from the road on which deterioration is predicted, and can reflect these on repair of the road.

### Second Example Embodiment

A configuration of a deterioration prediction system 10 according to a second example embodiment will be described with reference to the drawings. The deterioration prediction system 10 according to the second example embodiment is different in that the deterioration prediction unit 11 further acquires a repair plan and predicts a deterioration level of a road at a prediction time point. Therefore, the configuration of the deterioration prediction system 10 according to the second example embodiment will be described using the same block diagram as the configuration of the deterioration prediction system according to the first example embodiment illustrated in FIG. 3.

The deterioration prediction system 10 according to the second example embodiment includes the deterioration prediction unit 11 and the display control unit 12.

The deterioration prediction unit 11 acquires a history of road inspection data stored in the road inspection data storage unit 20, and acquires reference information and a repair plan received by the input device 21. In the repair plan, then, the deterioration prediction unit 11 generates a deterioration prediction model for predicting deterioration based on the history of the road inspection data, the reference information, and the repair plan. The deterioration prediction unit 11 generates a deterioration prediction model in consideration of improvement of a deterioration state of a road by implementation of repair according to the repair plan. For example, the deterioration prediction unit 11 generates a post-repair deterioration prediction model based on a repair area, time, and method. When repair is performed on a part of a road section, a post-repair deterioration prediction model is applied to the part, and a pre-repair deterioration prediction model is applied to the other part.

The deterioration prediction unit 11 acquires a future prediction time point from the input device 21. Then, the deterioration prediction unit 11 predicts a deterioration level of a road at a prediction time point using the deterioration prediction model including a post-repair deterioration prediction model (such as a deterioration curve).

The display control unit 12 outputs the display of the deterioration information depending on the deterioration level of a road at a prediction time point. For example, the display control unit 12 generates display data and outputs the generated display data.

The content output by the display control unit 12 is not limited to the deterioration information of the road depending on the deterioration level of the road at a prediction time point. For example, when the prediction time point is before implementation of repair, the display control unit 12 may display an area to be repaired in a superimposed manner on a map. The display control unit 12 may display the road in such a way that the road with a deterioration level lowered by the implementation of the repair plan can be distinguished from the others. As a result, even when there are some roads having the same deterioration level on the display screen, the user can easily grasp a certain road has deterioration that has been recovered by repair.

In a case where the deterioration level of the road changes or the type of deterioration changes due to a change in the prediction time point, the display control unit 12 may display and output it in an expression mode indicating the change.

### [Description of Operation]

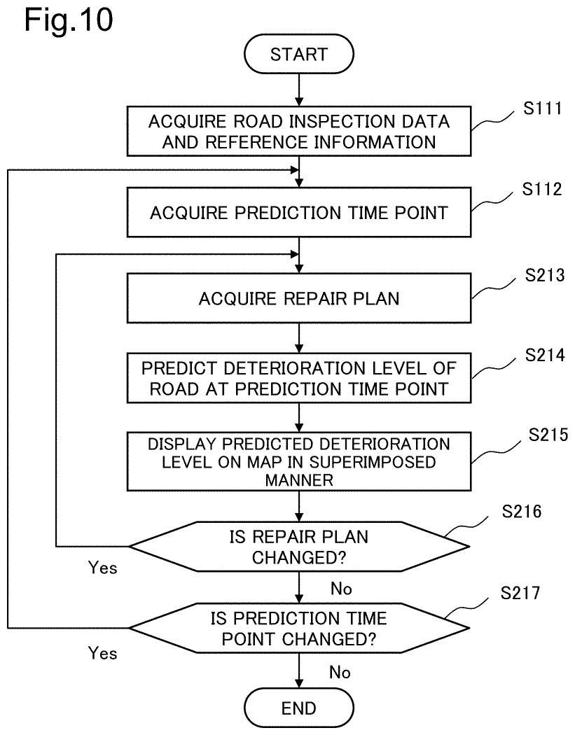

Next, an operation of the deterioration prediction system 10 according to the second example embodiment will be described with reference to the drawings. FIG. 10 is a flowchart illustrating an example of an operation of the deterioration prediction system 10 of the second example embodiment. In the description of the operation of the deterioration prediction system 10 according to the second example embodiment, the same step numbers are assigned to the same operations as those of the deterioration prediction system 10 according to the first example embodiment, and a description of them will be omitted. That is, in FIG. 10, descriptions of steps S111 and S112 are omitted.

The deterioration prediction unit 11 acquires a road repair plan (step S213). For example, the deterioration prediction unit 11 acquires a road repair plan from the input device 21. When the repair plan is described in the road inspection data storage unit 20, the deterioration prediction unit 11 may acquire the repair plan from the road inspection data storage unit 20.

The deterioration prediction unit 11 generates a deterioration prediction model by using a history of road inspection data, reference information, and the repair plan. The deterioration prediction unit 11 predicts a deterioration level of the road by applying the prediction time point to the generated deterioration prediction model (step S214).

The display control unit 12 displays the predicted deterioration level in a superimposed manner on the map (step S215). When the repair plan is changed (Yes in step S216), the input device 21 receives an input of another repair plan, and the deterioration prediction unit 11 acquires another repair plan (to step S213). When a plurality of repair plans are stored in the road inspection data storage unit 20, the deterioration prediction unit 11 may acquire another repair plan from the road inspection data storage unit 20.

When the repair plan is not changed (No in step S216), the deterioration prediction system 10 waits for reception of a change in the prediction time point. When the future prediction time point is changed (Yes in step S217), the input device 21 receives an input of another prediction time point, and the deterioration prediction unit 11 acquires another future prediction time point (to step S112). When the future prediction time point is not changed (No in step S217), the deterioration prediction system 10 ends the operation. The deterioration prediction system 10 may repeat the operations of steps S111 to S217.

### Display Examples

Next, an operation of the deterioration prediction system 10 according to the second example embodiment will be described with reference to display examples. Hereinafter, in the description of the display examples of the second embodiment, points different from the display examples of the first example embodiment will be described, and a description of overlapping points will be omitted.

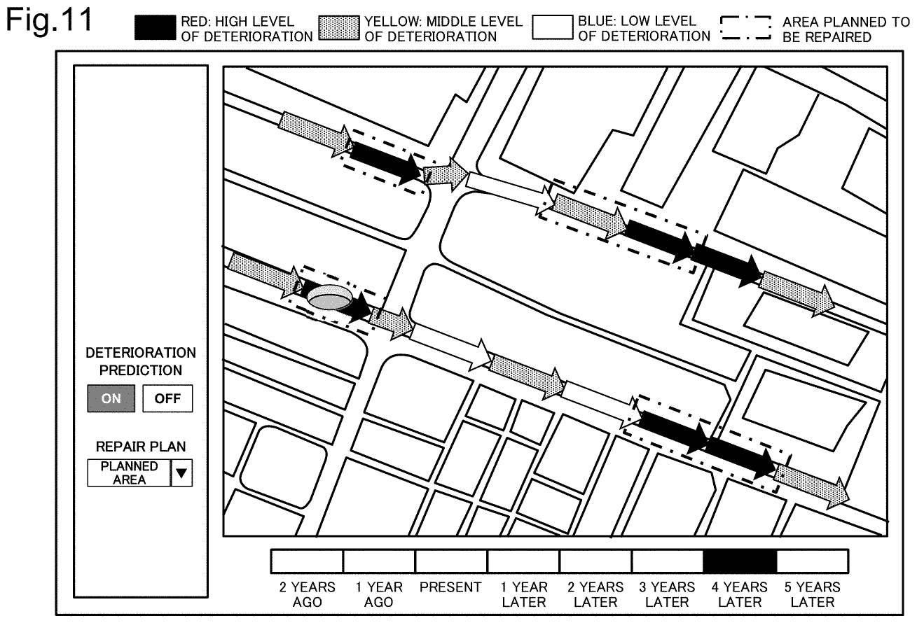

The deterioration prediction system 10 according to the second example embodiment displays the acquired information related to the repair plan in a superimposed manner on the map. FIG. 11 is a diagram illustrating an example in which an area to be repaired for a repair plan is added to the display example illustrated in FIG. 9. As illustrated in FIG. 11, the display control unit 12 displays an alternate long and short dash line surrounding arrows of a road serving as an area to be repaired in a superimposed manner on a map indicating a deterioration level of the road before implementation of repair based on a repair area and a repair time included in the acquired repair plan.

In the display example illustrated in FIG. 11, the user of the deterioration prediction system 10 can distinguish between an area to be repaired and an area not planned and grasp them for a road whose deterioration level is high by prediction.

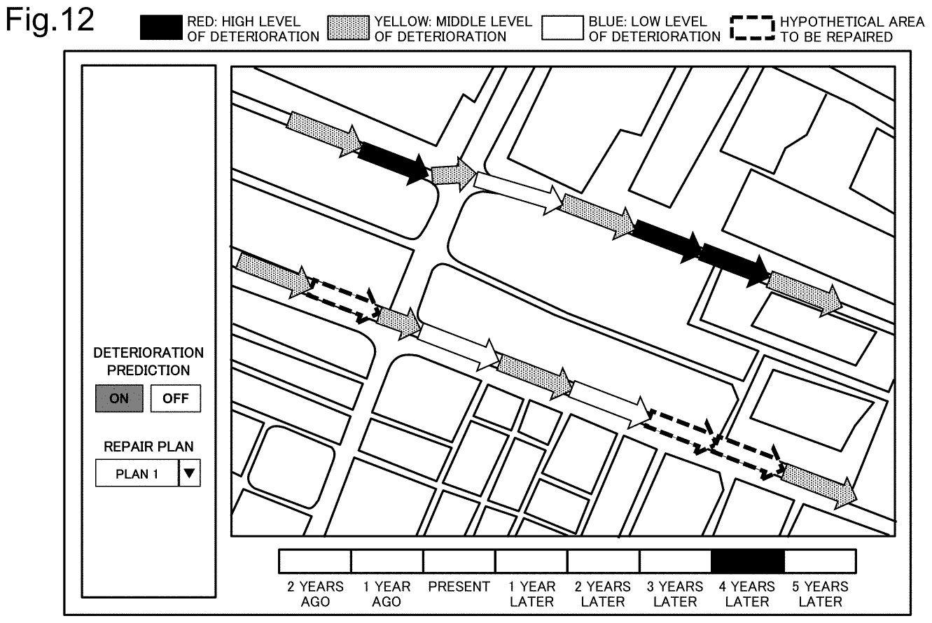

The deterioration prediction system 10 according to the second example embodiment displays a repair schedule related to the acquired repair plan in a superimposed manner on the map by reflecting the repair schedule on the deterioration prediction. The deterioration prediction system 10 generates a deterioration prediction model in consideration of a deterioration state of a road before and after implementation of repair according to the repair plan, and predicts a deterioration level of the road at the prediction time point based on the prediction time point and the generated deterioration prediction model. FIG. 12 is a diagram illustrating a display example of a deterioration level of a road four years later on which a repair plan 1 is reflected. For example, in a case where the prediction time point is four years later for an area to be repaired three years after the present time point in the repair plan, the area is displayed as a deterioration prediction on which the repair schedule is reflected. As to the deterioration level of the road four years later, on which the repair plan 1 is reflected, illustrated in FIG. 12, the number of areas with high deterioration is three, the number of areas with middle deterioration is eight, and the number of areas with low deterioration is six. Arrows are indicated by broken lines in such a way that the three areas that have been improved from high deterioration to low deterioration four years later by repair in the repair plan 1 can be distinguished from the same deterioration level (low deterioration).

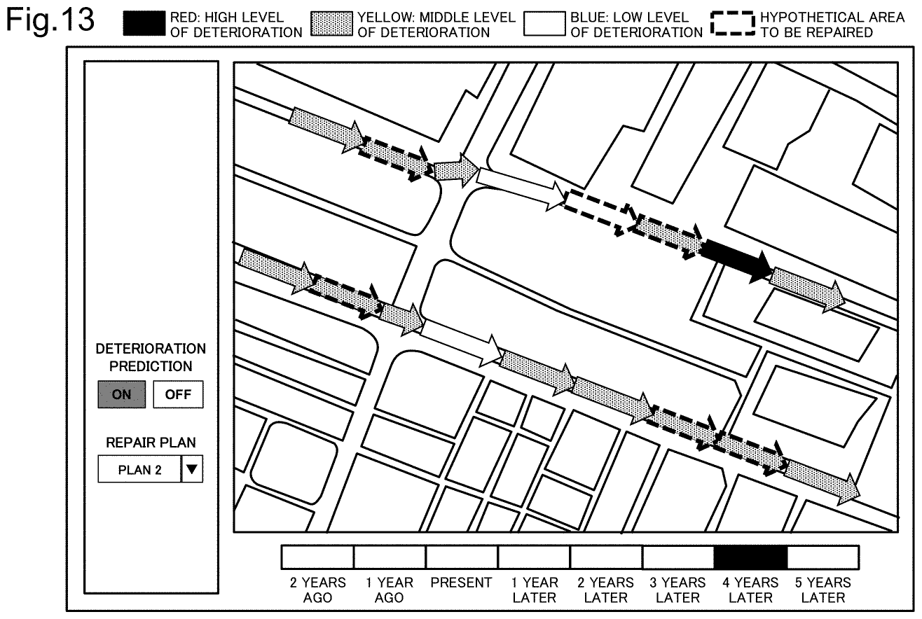

FIG. 13 is a diagram illustrating a display example of a deterioration level of a road four years later on which a repair plan 2 is reflected. FIG. 13 also displays the deterioration prediction on which the repair schedule is reflected when the prediction time point is set to 4 years later for the area to be repaired 3 years after the present time point in the repair plan 2. As to the deterioration level of the road four years later, on which the repair plan 2 is reflected, illustrated in FIG. 13, the number of areas with high deterioration is 1, the number of areas with middle deterioration is 13, and the number of areas with low deterioration is 3. In FIG. 13, improvement from high deterioration to middle deterioration after four years by repair in the repair plan 2 is made in five areas, and improvement from middle deterioration to low deterioration is made in one area. Arrows are indicated by broken lines in such a way as to be distinguishable from the same deterioration level (low deterioration).

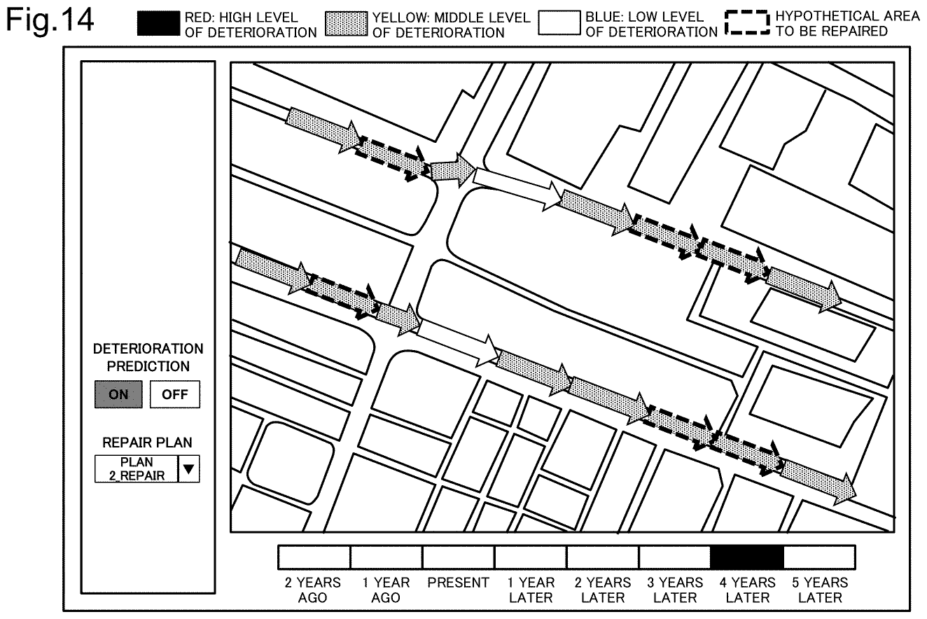

FIG. 14 is a diagram illustrating a display example of a deterioration level of a road four years later on which a revision proposal is reflected. In the prediction of the deterioration level of the road four years later, on which the repair plan 2 is reflected, as illustrated in FIG. 13, there is one road with high deterioration. For example, the user of the deterioration prediction system 10 registers a revision proposal of the repair plan 2 in the input device 21 or the road inspection data storage unit 20. The deterioration prediction unit 11 acquires the revision proposal of the repair plan 2 from the input device 21 or the road inspection data storage unit 20, and predicts the deterioration level of the road at the prediction time point based on the revision proposal of the repair plan 2.

In the revision proposal of the repair plan 2, two repair areas in the repair plan 2 are changed. The first one is that a road with middle deterioration four years later is not repaired. The second one is that a road with high deterioration four years later is repaired at the same time as other areas to be repaired.

As to the deterioration level of the road four years later, on which the revision proposal of the repair plan 2 is reflected, as illustrated in FIG. 14, the number of areas with high deterioration is 0, the number of areas with middle deterioration is 15, and the number of areas with low deterioration is 2. In FIG. 14, the display example on which the revision proposal of the repair plan 2 is reflected displays, in comparison with the repair plan 2, the deterioration level of the road four years later in which the number of areas with high deterioration changed from 1 to 0 and one area with deterioration changed from middle to low in the repair plan 2 remains to be middle deterioration in the revision proposal. The road that has been repaired at the prediction time point is indicated by an arrow with a broken line in such a way as to be distinguishable from the same deterioration level (middle deterioration).

As described above, the user of the deterioration prediction system 10 according to the second example embodiment can repeat the prediction while displaying the prediction level of the road on which the repair plan is reflected and inputting the repair plan.

### Description of Advantageous Effects

With the deterioration prediction system 10 according to the second example embodiment, an area and time to repair a road can be efficiently grasped. The reason is as follows.

The deterioration prediction system 10 includes the deterioration prediction unit 11 and the display control unit 12. The deterioration prediction unit 11 generates a deterioration prediction model for predicting a deterioration level on a road based on a history of the road inspection data, the reference information, and the repair plan. The deterioration prediction unit 11 predicts the deterioration level of the road at the prediction time point using the generated deterioration prediction model. The display control unit 12 displays the deterioration level of the road at the prediction time point in a superimposed manner on the map.

The user of such a deterioration prediction system 10 can grasp an area with high deterioration level at a prediction time point and a degree of future deterioration progress at a prediction time point from the road on which deterioration is predicted, and can reflect these on repair of the road. It is also possible to change the repair plan and efficiently grasp the area to be repaired and time.

(Hardware Configuration)

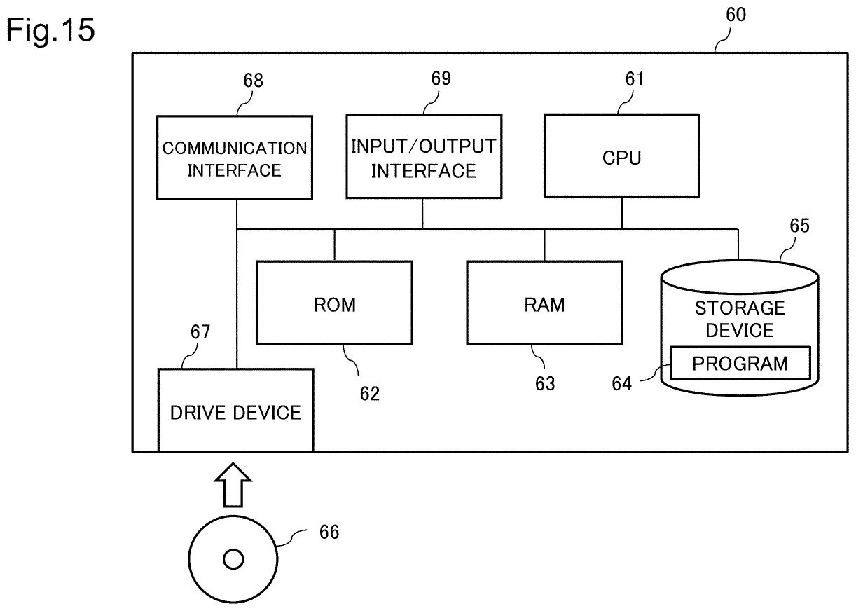

The deterioration prediction system 10 includes a computer 60 illustrated in FIG. 15. The deterioration prediction system 10 is achieved by a central processing unit (CPU) 61 executing the functions of the components of the deterioration prediction system 10 by a program 64. The function of each component may be achieved by the CPU 61 reading the program 64 from a read only memory (ROM) 62 or a storage device 65 and by the CPU 61 and a random access memory (RAM) 63 executing the read program 64. The components are the deterioration prediction unit 11 and the display control unit 12 of the deterioration prediction system 10.

It can also be understood that the deterioration prediction system 10 described above is configured by a computer-readable recording medium 66 in which a program for causing the CPU 61 to function is stored. The recording medium 66 is, for example, a hard disk drive, a disk medium detachable from a drive device 67, a memory card, or the like. For example, the components of the deterioration prediction unit 11 and the display control unit 12 of the deterioration prediction system 10 may be dedicated hardware implemented by an integrated circuit. The computer 60 may include a communication interface 68 and an input/output interface 70 connectable to a network. The deterioration prediction system 10 and the components may be decentrally arranged in a plurality of devices. In this case, they can function in the same manner as a single device, by communicably connecting the plurality of devices.

The present disclosure is not limited to the above-described example embodiments, and various modifications can be made, and example embodiments obtained by appropriately combining configurations, operations, and processes disclosed in different example embodiments are also included in the technical scope of the present disclosure.

The present disclosure has been particularly shown and described with reference to the above-described example embodiments as exemplary examples. However, the present disclosure is not limited to these example embodiments. That is, it will be understood by those of ordinary skill in the art that various aspect may be made in the present disclosure without departing from the spirit and scope of the present disclosure as defined by the claims.

This application is based upon and claims the benefit of priority from Japanese patent application No. 2020-057434, filed on Mar. 27, 2020, the disclosure of which is incorporated herein in its entirety by reference.

### REFERENCE SIGNS LIST

5 Road management system
10 Deterioration prediction system
11 Deterioration prediction unit
12 Display control unit
20 Road inspection data storage unit
21 Input device
22 Display device

What is claimed is:

1. A deterioration prediction system comprising:
at least one memory configured to store instructions; and
at least one processor configured to execute the instructions to:
predict a deterioration level of the road at prediction time points according to road inspection data and the prediction time points, the road inspection data obtained by inspecting a road and the prediction time points indicating future time points; and
superimpose the deterioration level on a map for each of the prediction time points in a display mode according to the deterioration level.

2. The deterioration prediction system according to claim 1, wherein the at least one processor is further configured to execute the instructions to:
predict a change in a deterioration type on the road at the prediction time point, and
superimpose the predicted change in the deterioration type on the map.

3. The deterioration prediction system according to claim 1, wherein the at least one processor is further configured to execute the instructions to:
predict the deterioration level of the road at the prediction time point based on the road inspection data, a repair plan, and the prediction time point.

4. The deterioration prediction system according to claim 3, wherein
the repair plan includes at least one of a repair area, a repair time, and a repair method.

5. The deterioration prediction system according to claim 3, wherein the at least one processor is further configured to execute the instructions to:
superimpose an area to be repaired on the road at the prediction time point on the map based on the repair plan.

6. The deterioration prediction system according to claim 3, wherein the at least one processor is further configured to execute the instructions to:
superimpose the deterioration level on the map in a display mode indicating that the deterioration level of the road at the prediction time point is that of after repairment, based on the repair plan and the prediction time point.

7. The deterioration prediction system according to claim 3, wherein the at least one processor is further configured to execute the instructions to:
predict the deterioration level of the road at the prediction time point based on a plurality of the repair plans acquired, and
display the deterioration level in a display mode according to the deterioration level of the road at the prediction time point for each of the repair plans.

8. The deterioration prediction system according to claim 3, wherein the at least one processor is further configured to execute the instructions to:
generate a deterioration prediction model that predicts deterioration of the road based on the road inspection data, and predict the deterioration level of the road at the prediction time point based on the generated deterioration prediction model.

9. A deterioration prediction method comprising:
predicting a deterioration level of the road at prediction time points, based on road inspection data and the prediction time points, the road inspection data obtained by inspecting a road and the prediction time points indicating future time points; and
superimposing the deterioration level on a map for each of the prediction time points in a display mode according to the deterioration level.

10. A non-transitory recording medium for storing a program that causes a computer to execute:
predicting a deterioration level of the road at prediction time points, based on road inspection data and the prediction time points, the road inspection data obtained by inspecting a road and the prediction time points indicating future time points; and
superimposing the deterioration level on a map for each of the prediction time points in a display mode according to the deterioration level.
